(19) United States
(12) Patent Application Publication
(10) Pub. No.: US 2007/0019821 A1
(43) Pub. Date: Jan. 25, 2007

(54) Illuminating headphones

(75) Inventor: James P. Dudley, Sacramento, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Design Annex, Sacramento, CA (US)

(21) Appl. No.: 11/350,471

(22) Filed: Feb. 8, 2006

Related U.S. Application Data
(60) Provisional application No. 60/652,229, filed on Feb. 11, 2005.

(51) Int. Cl. H04B 3/00

(52) U.S. Cl. 381/77

(57) ABSTRACT

A personal headphone designed to be used with personal music players, such as, for example, an iPod, MP3, Portable CD, etc., that provides sound, preferably in stereo, from the personal music player to a user's ears. It may also be used with other portable devices that provide sound such as, for example, cellular phones, DVD players and portable computers. In the case of a phone, the personal headphone may include a microphone. The personal headphone includes an illuminating headphone wire that is a combination of at least one common copper conductor that is used in typical portable headphone designs, with the addition of at least one flexible, cable like electroluminescent wire paired with the copper conductor to give the appearance that the headphone wires are glowing.

### CROSS-REFERENCES TO RELATED APPLICATIONS

NOT APPLICABLE

This application is a non-provisional application and claims the benefit of Application No. 60/652,229, filed Feb. 11, 2005, entitled “Illuminating Headphones,” the disclosure of which is incorporated herein by reference for all purposes.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to personal headphones, and more particularly to headphones with illuminated connecting wires.

2. Description of Related Art

Personal music players are ubiquitous. Typically, earbud-type headphones are used for audio output instead of speakers to provide for personal listening. Such headphones are typically connected to the music player using a pair of wires or a cable, although wireless configurations also exist. Also, cellular or mobile phones are extremely popular. Many people now use “hands-free” units that often include at least one headphone that may coupled to the phone with at least one wire or cable.

### BRIEF SUMMARY OF THE INVENTION

The present invention enhances the personal experience of a headphone user by providing a set of wires or a cable between the earbuds and a portable electronic device such as a personal music player that illuminates. In one aspect of the invention, the illumination is steady. In another aspect of the invention, the illumination flashes in response to changing audio characteristics of the music. In another aspect of the invention, the color of the illumination changes. In another aspect of the invention, the color of the illumination is user selectable.

Further aspects of the invention will be brought out in the following portions of the specification, wherein the detailed description is for the purpose of fully disclosing preferred embodiments of the invention without placing limitations thereon.

### BRIEF DESCRIPTION OF THE DRAWINGS

FIG. 1 is a schematic illustration of a headphone arrangement in accordance with the present invention;

FIG. 2 is a sectional view of an illuminating headphone wire in accordance with the present invention as seen along the line A:A in FIG. 1;

FIG. 3 is a top plan view of a control box in accordance with the present invention; and

FIG. 4 is a flow chart illustrating an example of circuitry for the present invention.

### DETAILED DESCRIPTION OF THE INVENTION

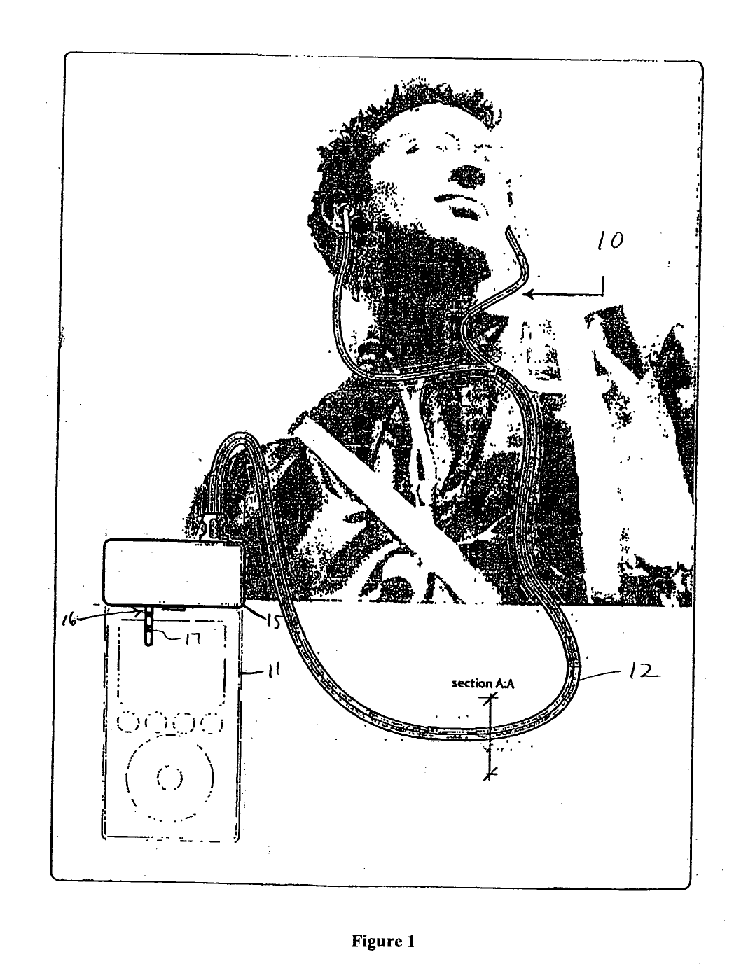

As shown in FIG. 1, the present invention is directed to a personal headphone 10 designed to be used with personal music players 11, such as, for example, an iPod, MP3, Portable CD, etc., that provides sound, preferably in stereo, from the personal music player to a user's ears. It may also be used with other portable devices that provide sound such as, for example, cellular phones, DVD players and portable computers. In the case of a phone, the personal headphone may include a microphone. The personal headphone includes an illuminating headphone wire 12 that is a combination of at least one common copper conductor 13 that is used in typical portable headphone designs, with the addition of at least one flexible, cable like electroluminescent wire (EL Wire) 14 paired with the copper conductor to give the appearance that the headphone wires are glowing.

Preferably, there is a control box 15 that mounts to the top of personal music player 11 that uses a mini phone jack 16 to connect headphones to the player. The control box includes a male coupler 17 for coupling to the personal player via the mini phone jack. As may be seen in FIG. 3, controls 18 may be provided on the control box for controlling various aspects of the invention and the personal player if desired, such as, for example, power on/off, muting, color of illumination and pattern of illumination. A receptacle 19 for removably coupling the headphone wire to the control box is also provided. Alternatively, the headphone wire may be permanently coupled to the control box.

The control box preferably has four main functions:

(1) To provide power for the EL Wire, as not to drain power from the batteries that are internal to the player, therefore not reducing play time of the player;

(2) Ability to pick up current spikes which would indicate the beat of the music and may be used to pulse the light to the music;

(3) Ability to temporarily mute the music to hear outside sounds a/or conversation; and

(4) Switch colors or alternate colors for the multi-color unit.

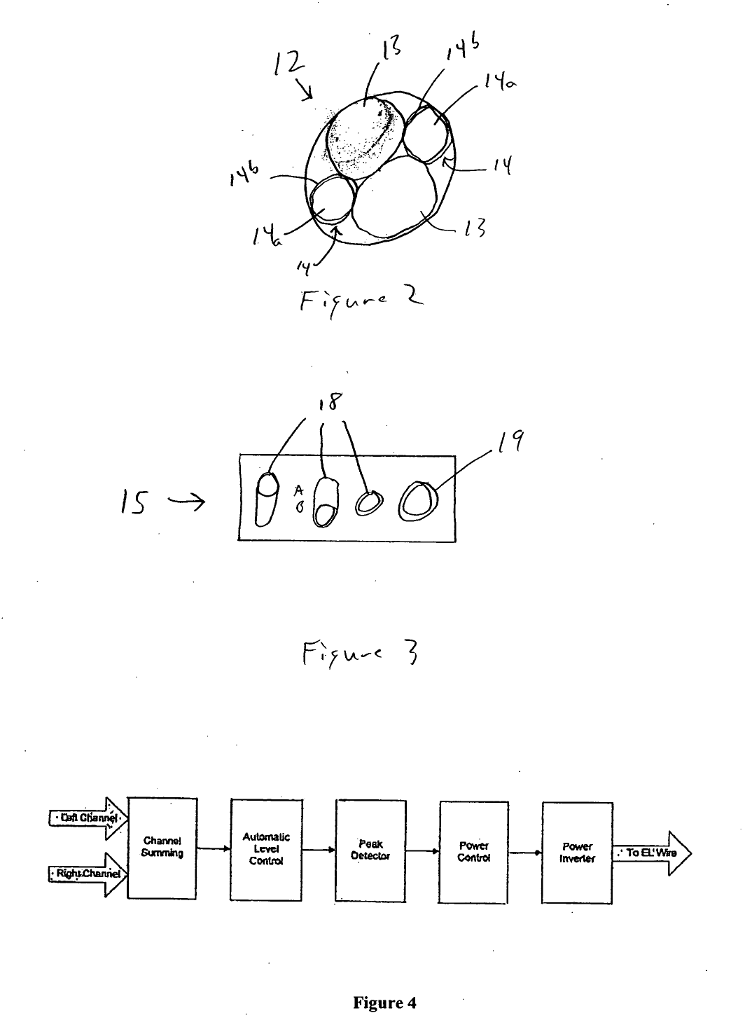

With reference to FIG. 4, a preferred embodiment of the electronics used in the present invention is described. The primary function of these electronics is to control the illumination of the electroluminescent wire used in the headphones. The electronics may be designed to continuously light the wire, flash the wire or flash the wire based on the beat of the music. When flashing the wire based on the beat, additional circuits may be added to control the intensity of the light based on the intensity of the music. Such circuitry is known to those skilled in the art.

Depending on the design approach and unit material cost, other features may be added into the electronic design. These features may include auto power off when no sound has been detected for a preset length of time, also a sound muting function. Such features may be added by one skilled in the art.

Electroluminescent wire is a relatively new technology. It is a versatile material that may be used for many lighting effects. EL Wire is a cable that glows. The glowing is accomplished by an electroluminescent phosphor that emits light when a voltage is applied across it. The glowing color of the EL Wire is controlled by the variation of phosphor coating and the color of the plastic outer cover. EL wire consists of an inner wire 14a with the phosphor coating applied to it, and an outer wire 14b wrapped around it. This pair of wires is encapsulated in a protective plastic coating. EL wire is commercially available, and an example of EL technology suitable for use with the present invention may be found in U.S. Pat. No. 5,869,930 which is incorporated herein by reference in its entirety.

To make an EL Wire glow, an AC voltage is applied between the inner and outer wires. Typically, this voltage is between 80 and 120 volts RMS AC at a frequency between 200 and 4000 hertz. To develop the power that is required by an EL Wire, an inverter is used to convert low voltage DC power (Battery) to a high frequency, high voltage AC needed by the EL Wire.

Note that the power is applied between the inner and outer wires 14a, 14b of the EL Wire 14 and not between the two ends of the EL Wire. Also, the power used by EL Wire is at a high enough level to cause an electrical shock to a human. Great care should be used in the manufacturing and assembly process to protect against electrical shocks.

With further reference to FIG. 4, electronics for operation of the present invention is presented as a block diagram. Each of the blocks illustrated are detailed in the text that follows.

Battery Power

The electronics as described may be powered by two AAA or AA alkaline batteries. The duration of the batteries would very depending on the type of batteries selected, mode of operation and the length of the EL Wire. The duration may be as long as 20 hours or as short as 4 hours.

Channel Summing

As with stereo audio, the left and right channel may have different components of sound. The summing block in this application is used to add together the left and right channels so that the following circuits may use to sum the left and right audio channel.

Automatic Level Control

Because this device is attached after the player's audio amplifier, some type of level control is preferred to compensate for changes in user volume level adjustments. As the user changes the volume level, the sensitivity to the volume would also need to be changed. If some type of level control is not used, the headphone wire may not light at low volume levels and may stay on continuously at high volume levels. A manual adjustment may be implemented, but for this application, an Automatic Level Control (ALC) version is preferred. This type of level control will produce the same light control results, regardless of the volume level selected by the user.

Peak Detector

To control the EL Wire based on the intensity of the sound from the player, a peak detector is used. This part of the electronics looks for large and intense changes in the sound levels and signals downstream circuits to either turn on the illumination or control the intensity of the illumination.

Power Control

This stage of the electronics controls the intensity of the EL Wire based on the signal from the peak detector. There are various modes that the power control circuit may operate in, as follows:

It may ignore the signal from the peak detector and just turn on the EL Wire continuously;

It may ignore the signal from the peak detector and flash the EL Wire at some preprogrammed rate. Even a flash pattern may be controlled by this stage;

It may use the information from the peak detector to flash the EL Wire at a rate that matches the beat of the sound; and

It may use the information from the peak detector to control the intensity of the EL Wire at a rate that matches the beat of the sound. To control the intensity of illumination, the power control circuit would control the frequency of the inverter. The higher the frequency the stronger the illumination.

Power Inverter

This stage produces the high voltage and frequency needed to illuminate the EL Wire. If intensity control is not used, then the inverters will only provide a method to turn on and off the EL Wire. If intensity control is used then the inverter will receive frequency control from the power control circuit. Changing the frequency output of the inverter is the preferred method to control the illumination intensity of the EL. Wire.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art.

What is claimed is:

1. A communication conduit for providing a signal from a source to at least one output, the communication conduit comprising at least one illuminating cable.

2. A communication conduit in accordance with claim 1 wherein the illuminating cable comprises at least one conductive wire for carrying the signal from the source to the at least one output.

3. A communication conduit in accordance with claim 2 wherein the illuminating cable comprises a primary cable and two secondary cables.

4. An apparatus for providing audio from an audio source to at least one audio outlet, the apparatus comprising:
the at least one audio outlet;
at least one communication conduit for communication between the audio source and the audio outlet; and
at least one illuminating cable coupled to the at least one audio outlet and that may be removably coupled to the audio source.

5. An apparatus in accordance with claim 4 further comprising a microphone.

6. An apparatus in accordance with claim 4 wherein the apparatus comprises two audio outlets.

7. An apparatus in accordance with claim 6 further comprising a microphone.

8. An apparatus in accordance with claim 4 wherein the apparatus comprises a single audio outlet.

9. An apparatus in accordance with claim 8 further comprising a microphone.

10. An apparatus in accordance with claim 4 wherein the communication conduit comprises at least one conductive wire within the illuminating cable for carrying a signal from the audio source to the at least one audio output.

11. An apparatus in accordance with claim 10 wherein the apparatus comprises two audio outlets and the illuminating cable comprises a primary cable and two secondary cables.

12. An apparatus for providing audio from an audio source to at least one audio outlet, the apparatus comprising:
the at least one audio outlet;
at least one communication conduit for communication between the audio source and the audio outlet;
a control box that may be removably coupled to the audio source; and
at least one illuminating cable coupled to the at least one audio outlet and coupled to the audio source.

13. An apparatus in accordance with claim 12 wherein the illuminating cable is removably coupled to the control box.

14. An apparatus in accordance with claim 12 wherein the control box includes a power source for the illuminating cable.

15. An apparatus in accordance with claim 14 wherein the control box includes switch for controlling the power source.

16. An apparatus in accordance with claim 12 wherein the control box controls illumination of the illuminating cable such that the illuminating cable illuminates based upon the audio signal.

17. An apparatus in accordance with claim 12 wherein the control box controls illumination of the illuminating cable such that the illuminating cable is illuminated continuously during use.

18. An apparatus in accordance with claim 12 wherein the control box provides color control for illumination of the illuminating cable.

19. An apparatus in accordance with claim 12 wherein the control box provides mute control for the audio.

20. An apparatus in accordance with claim 12 wherein the communication conduit comprises at least one conductive wire within the illuminating cable for carrying a signal from the audio source to the at least one audio output.

21. An apparatus in accordance with claim 20 wherein the apparatus comprises two audio outlets and the illuminating cable comprises a primary cable and two secondary cables.

22. A system for providing audio to a user, the system comprising:
an audio source;
at least one audio outlet;
a communication conduit between the audio source and the at least one audio outlet; and
an illuminating cable coupled to the at least one audio outlet.

23. A system in accordance with claim 22 wherein the communication conduit comprises at least one conductive wire within the illuminating cable for carrying a signal from the audio source to the at least one audio output.

24. A system in accordance with claim 23 wherein the system comprises two audio outlets and the illuminating cable comprises a primary cable and two secondary cables.

25. A system in accordance with claim 22 wherein the audio source is one of a group comprising a compact disc player, a digital video disc player, an mpeg player and a telephone.

26. A system in accordance with claim 22 further comprising a control box removably coupled to the audio source and coupled to the illuminating cable.

27. A system in accordance with claim 26 wherein the illuminating cable is removably coupled to the control box.

28. A system in accordance with claim 26 wherein the control box includes a power source for the illuminating cable.

29. A system in accordance with claim 28 wherein the control box includes switch for controlling the power source.

30. A system in accordance with claim 26 wherein the control box controls illumination of the illuminating cable such that the illuminating cable illuminates based upon the audio signal.

31. A system in accordance with claim 26 wherein the control box controls illumination of the illuminating cable such that the illuminating cable is illuminated continuously during use.

32. A system in accordance with claim 26 wherein the control box provides color control for illumination of the illuminating cable.

33. A system in accordance with claim 26 wherein the control box provides mute control for the audio.

34. A system in accordance with claim 26 wherein the communication conduit comprises at least one conductive wire within the illuminating cable for carrying a signal from the audio source to the at least one audio output.

35. A system in accordance with claim 34 wherein the apparatus comprises two audio outlets and the illuminating cable comprises a primary cable and two secondary cables.

36. A method of illuminating a cable, the method comprising:
coupling the cable to an audio source and to an audio outlet; and
illuminating the cable from within the cable.

37. A method in accordance with claim 36 further comprising coupling a control box to the audio source and the cable between the audio source and the cable, and further comprising providing power to the cable from the control box to thereby illuminate the cable.

38. A method in accordance with claim 37 further comprising controlling illumination of the cable with the control box such that the cable illuminates continuously during use.

39. A method in accordance with claim 37 further comprising controlling illumination of the cable with the control box such that the cable illuminates based upon an audio signal from the audio source.
